(19) United States
(12) Patent Application Publication
(10) Pub. No.: US 2020/0051297 A1
(43) Pub. Date: Feb. 13, 2020

(54) Method and system for creating and displaying derivatives and variations of existing Scalable Vector Graphic images

(71) Applicants: Stacey Tipton Reiman, Anchorage, AK (US); Robert K. Reiman, Anchorage, AK (US)

(72) Inventors: Stacey Tipton Reiman, Anchorage, AK (US); Robert K. Reiman, Anchorage, AK (US)

(21) Appl. No.: 16/100,189

(22) Filed: Aug. 9, 2018

(51) Int. Cl. G06T 11/60; G06F 17/30; G06T 11/00; G06T 15/00

(52) U.S. Cl. CPC G06T 11/60; G06T 15/005; G06T 11/001; G06F 17/30923

(57) ABSTRACT

This patent describes a method and system of editing an existing SVG image to create multiple derivative images by importing either complex or compound path images into a data object, processing the data into a useful form, applying further processes to vary scale, hue, luminosity, saturation, stroke, rotation, opacity, and other properties of the image, and displaying those derivative images simultaneously as an aid to refining the design.

### RELATED APPLICATIONS

This application claims the benefits of the Provisional Patent Application No. 62/542,817, filed Aug. 9, 2017.

### BACKGROUND OF THE INVENTION

Scalable Vector Graphics (SVG) is a vector graphics standard established by the World Wide Web Consortium (W3C), an international standards organization for the World Wide Web. SVG is an XML-based vector image format for two-dimensional graphics that has support for interactivity and animation. Vector graphics, and particularly SVGs, offer an advantage over raster graphics in that they maintain clarity as they scale. An SVG image is rendered based upon the data that describes its shape, scale, color, and other properties.

Because SVG images are expressed as XML files, SVG images can theoretically be created and edited with a text editor, but such would be very time consuming and require specialized expertise. Instead, SVG images are typically created using vector graphics editing programs, such as InkScape®, available from Software Freedom Conservancy Corp., of New York, or Adobe Illustrator®, available from Adobe Systems Inc., of California. These graphics editing programs all operate through a Graphics User Interface (GUI). To edit an existing SVG graphic in these editing programs requires applying a selected operation to an element of the image to rewrite the XML file. The usual manner of creating of variations of an existing SVG image is generally accomplished by first creating multiple identical images in the GUI and then modifying each image manually to create each variation. Adobe has also made provision to create and import data into an image file by a merge function to create variations of images, but it is technical, cumbersome, time-consuming compared to this invention and cannot be effected solely from its user interface (see https://helpx.adobe.com/illustrator/using/data-driven-graphics-templates-variables.html) Unlike these other methods, the method and system described herein enables a user to programmatically create and display multiple variations simultaneously from the user interface or even automatically through the setting of defaults or variables.

While an SVG file is difficult to parse in its native form of XML, the data-based nature of an SVG graphic makes it possible to convert the paths or shapes and other properties of an image into an easier to parse non-relational data format such as Javascript Object Notation (JSON), so that the image data can be more easily accessed and manipulated in the resulting data array(s) or data object(s). Once the image is imported into the data object(s) in a useful form, the data values for each of the properties for each element, such as color (hue, saturation, luminosity) stroke, scale, and rotation, can be easily manipulated programmatically or through a user interface that allows the setting of values for the properties. Then, by setting random or sequential or user-selected values in a property, multiple variations of the digital image can be created and displayed simultaneously with the original. This allows a user to rapidly create and compare the multiple variations to visually drill down on a preferred design. By then selecting a new master from the variations and more narrowly defining the limits of the properties being varied, the design can be further refined.

Since the properties of each element are defined in the data object, and since it is possible to define an property for a specific element by assigning a variable (such as “sky” for the color property) which can then be defined by a call to outside data (such as time of day) or by reference to the property of another element (i.e. set hue +2 shades darker than that of element x), additional properties, variables and rules can be established for the image to programmatically create a desired variation.

### BRIEF SUMMARY OF THE INVENTION

This invention is a computer method and system is described for creating derivatives and variations of a master SVG image.

First, a method and system is described for creating a useful data object(s) for an existing SVG image for the specific purpose of manipulating that data to create derivative images. In the case of complex SVG graphic images (images containing a mixture of SVG elements, such as groups, paths, or shapes) this is done by inputting the data for each element to create the data object or objects. In the case of an image containing a compound path or paths, the compound paths are split by a programmatic operation into separate elements and the data for the resulting elements is incorporated into the data object(s) for that image.

This method and process also includes the option for the user to create additional properties in the data object for each image, and/or to define variables or rules for any of the properties in the data object, and/or to create groups for specific properties (i.e. color) through data object(s) and/or to further organize the elements for proper manipulation and display.

A method and system is also described for the creation of derivatives of the original or “master” SVG graphic by manipulating the values in one or more of the properties and/or variables (including but not limited to the size, color, hue, luminosity, saturation, pallette, stroke, gradient, opacity and rotation) for one or more of the elements contained in the data object, by assigning a number of stepped or random values within defined parameters, or from a specific set of values.

A method and system is described to then display one or more variations of the master SVG graphic created as described above simultaneously with the master SVG image, and allow further manipulation of the images by selection of a new master SVG image from those displayed, upon which the process and methods described above can be repeated.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 depicts a flowchart of the embodiment of the method and system in its entirety as reflected in claim 1, and other claims referencing claim 1 directly or indirectly.

FIG. 2 depicts a flowchart reflecting in detail the embodiment of the parsing and processing of the compound image file to produce a usable data object(s) for use in this invention.

FIG. 2A is a flow chart reflecting in detail the method and system of sorting elements to correct for obstructed elements.

FIG. 2B is a flow chart reflecting the method and system for determining symmetry of elements useful for of creation of intelligent coloring groups.

FIG. 3 is a flow chart depicting the methods and system for generation of variations of the master image.

FIG. 4 depicts an example of a the display of the master image and variations derived from that image by the method and processes herein described. This particular example shows the random variation of color and stroke-width in greyscale.

FIG. 5 depicts another example of a user interface for display of the master image and variations. This particular example shows stepped variations of color, specifically skin color.

### DETAILED DESCRIPTION

### I. Introduction

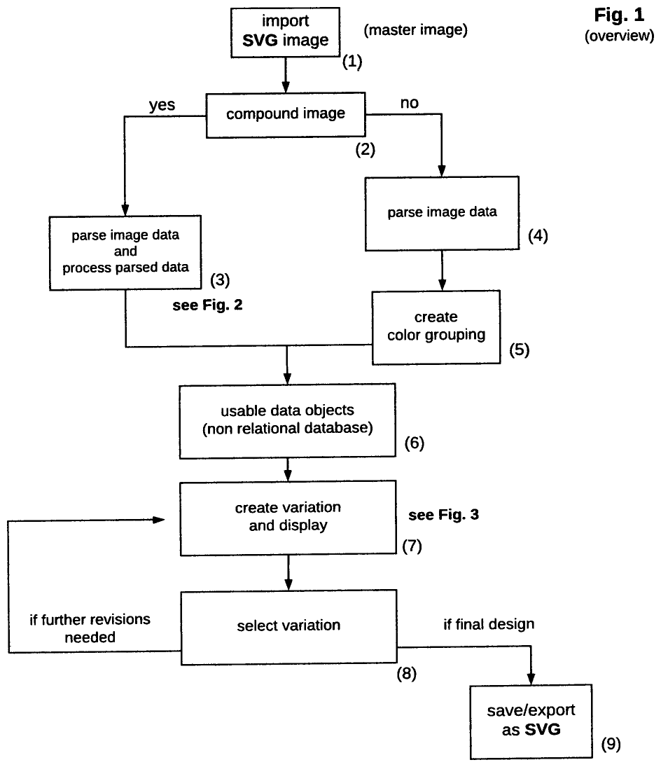

In its totality, this is a description of a method and system that is a combination of the following methods and systems whereby an existing SVG graphic image, whether or not comprised of a compound path or a variety of other paths or shapes, is manipulated to create variations and derivatives of the initial master SVG graphic image, and whereby those images are displayed in a useful manner and output in a useful form. See FIG. 1.

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### 2. Definitions.

The term “element” as used herein is defined as a shape or path of an SVG image in its original XML form or as parsed into its constituent key value pairs in a non- relational database (i.e. JSON). One or more elements, as converted, combine to create a data object or objects representative of the original SVG image.

The term “property” as used herein refers to the key value pair in the non-relational database (i.e. JSON). For example, a property would be {stroke: “black”} where “stroke” is the key and “black” is the value.

### 3. Embodiment.

In the described embodiment of this invention, a master SVG graphic is created by the user using a third party SVG creator, such as Adobe Illustrator, Inkscape or similar program, or otherwise imported from an outside source into the user's computer. FIG. 1(1).

Once the image is created or imported in a SVG format, this method and system then converts and organize the paths, shapes and/or data contained in the master SVG image into a useful data object of identifiable elements. This is done by a programmatic operation that:

a. Identifies whether the master SVG graphic image contains a compound path or paths; FIG. 1(2)

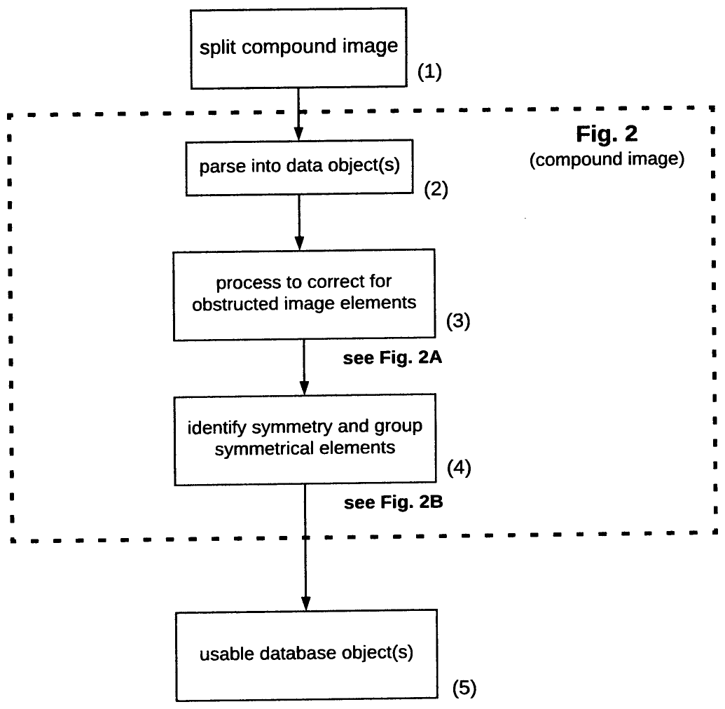

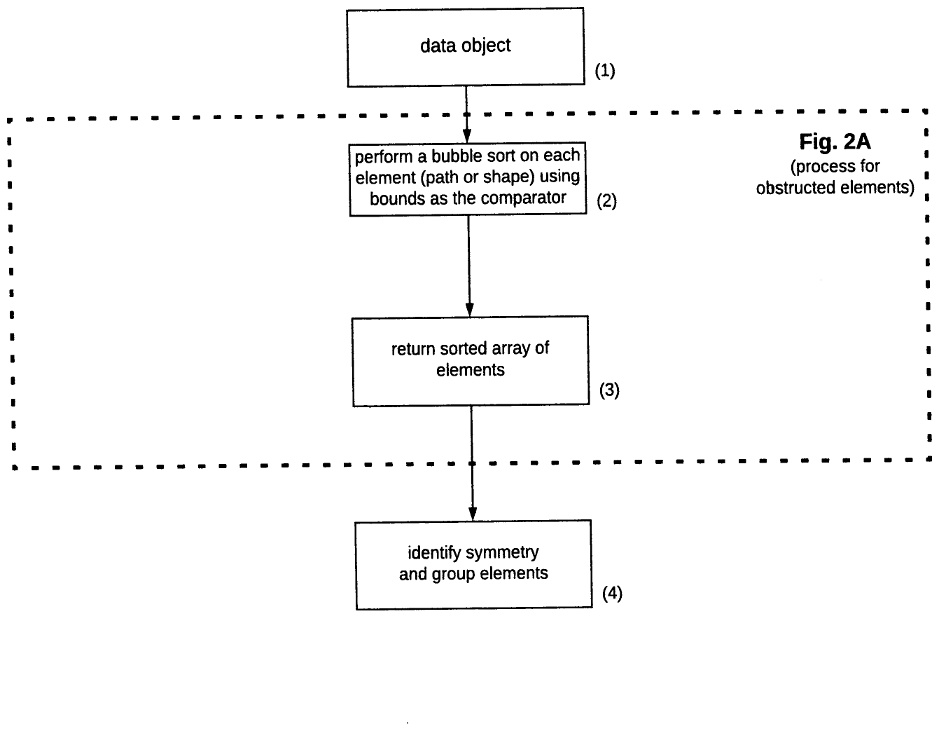

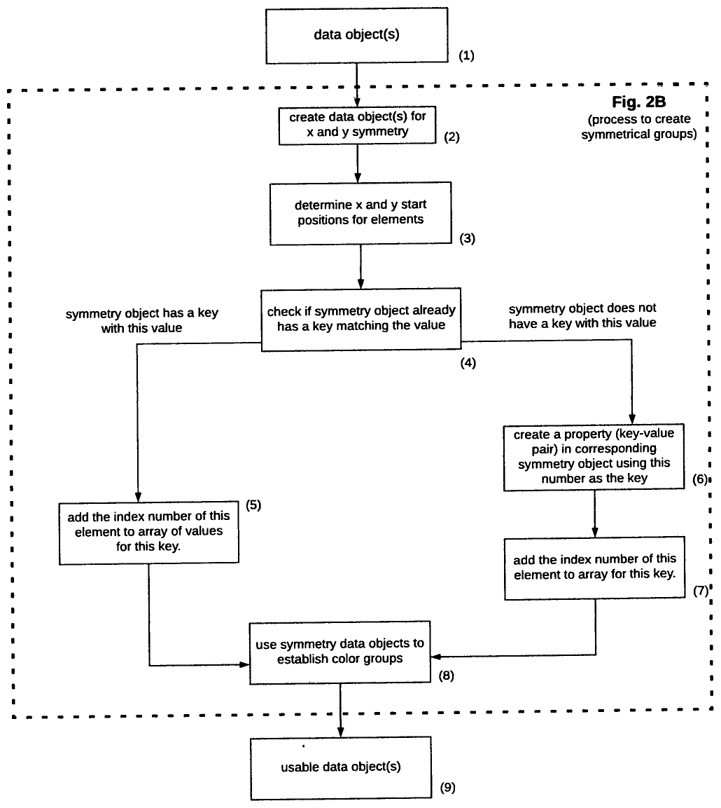

b. If the graphic includes a compound path, a programmatic process splits the compound path into separate paths; this is done automatically for single path compound path images, and optionally for complex images containing a compound path or paths; FIG. 1(3), FIG. 2(1).

c. Then, for the master graphic image, inputs the properties (that may include but is not limited to path or shape definition, scale, color, hue, luminosity, saturation, opacity, stroke width and/or stroke color), for each element into a nonrelational database (i.e. JSON) data object or objects for that image; FIG. 1(6), FIG. 2(5).

d. Identifies and inputs the properties of the elements in a complex master image into group(s) (i.e. for color groupings) and/or nonrelational database (i.e. JSON) data object(s); FIG. 1(3), FIG. 1(5), FIG. 2(4), FIG. 2B.

e. Identifies and converts shapes in complex images into identifiable elements and inputs the properties of those elements into nonrelational database (i.e. JSON) data object(s) for that image. FIG. 1(4).

This method and system may then also include a programmatic operation wherein the elements in an image may be further processed to adjust the organization of those elements, as necessary to allow the proper viewing of the image. FIG. 1(3), FIG. 2(3), FIG. 2A. These methods and processes are intended to gather available information from the image to intelligently create variations.

It is not unusual for single path compound images to contain hidden layers especially those that have had multiple paths merged into the compound path image. To correct for this issue, a programmatic operation is conducted to detect if one element would entirely obstruct the view of another element by comparing the dimensions and position of the two elements. In this embodiment, for efficiency purposes, this comparison is made through a bubble sort comparing top, bottom, left and right values. FIG. 2A. If the lower element's dimensions are entirely within the dimensions of the upper element, then the lower element is considered obstructed and the two elements are reordered. FIG. 2A(2). Based upon testing, this operation is very effective and has minimal false positives for single path compound images. An operation is made available through the user interface for manual arrangement of the order of the elements in the unlikely event that it is necessary to correct an erroneous reordering.

With respect to single path compound images that have been parsed into multiple elements, a programmatic operation is run whereby the elements are compared for symmetry on the x and or y axes by an operation that compares the starting point of the paths for those elements to determine if any elements are symmetrical on the x and/or y axes. FIG. 2B. An offset value can be set to test for elements that are symmetrical but contain a slight error in dimensions. These elements are then grouped to be colored identically as the default.

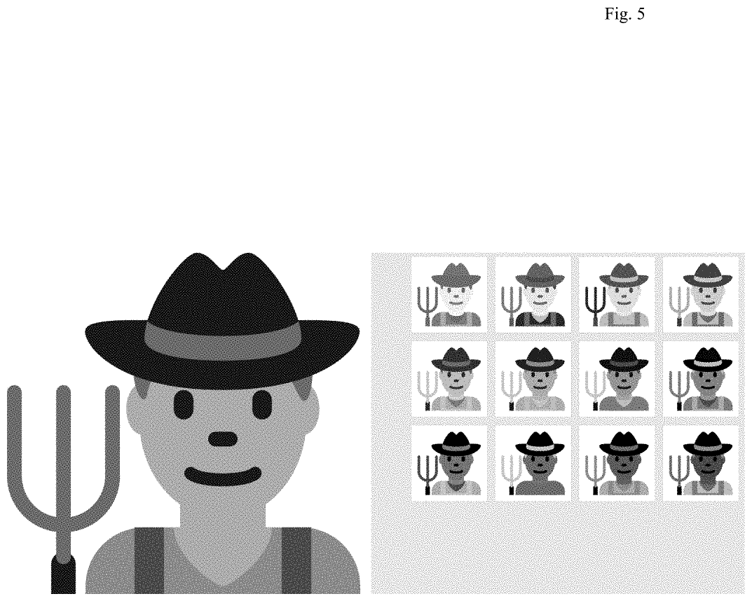

By applying a color palette with a different color (or grayscale) assigned to each element or group of elements of the master image, the derivative image or images (including those whose master is an all-black compound path SVG image) can be displayed with each resulting element drawn in a contrasting color (or shade of grayscale) in order to depict the separate individual elements that may be further manipulated in this process. FIG. 5 for example.

With respect to complex images, similar hue colors of the master image may be grouped manually or programmatically within the data object(s), so any single color groups in the image, such as “yellows” or “reds,” can be manipulated (or excluded from manipulation) as a group. Relative lightness and darkness inside of these hue groups can be detected by a programmatic operation that compares relative hues, so that the relative color shades may be preserved during the manipulation process.

All these operations may be set to operate either manually or programmatically.

Once the data for the master image has been parsed and processed into the usable data object(s) (FIG. 1(6)), and the elements are properly ordered, the SVG image can then be drawn in the user interface in a form identical to the initial image, except for any properties that may be intentionally omitted in the parsing process.

The result of the foregoing method and process is the creation of data object(s) that contains the definition of the master SVG graphic image, and allows for the manipulation of one or more of the properties of that image by variation of the values in such property(s) through this method and process.

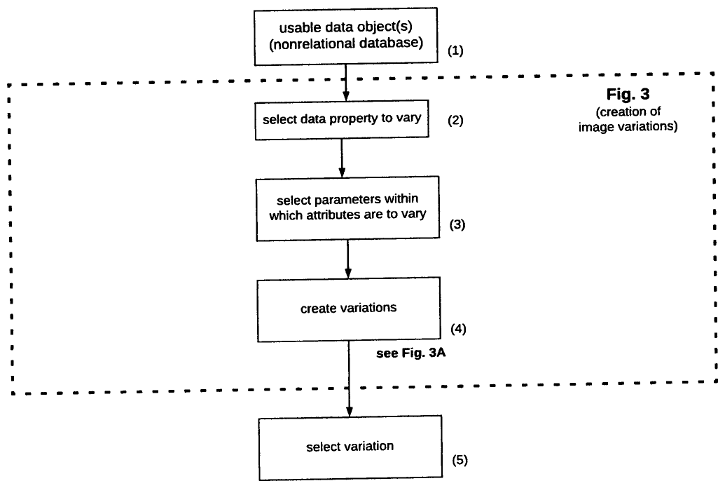

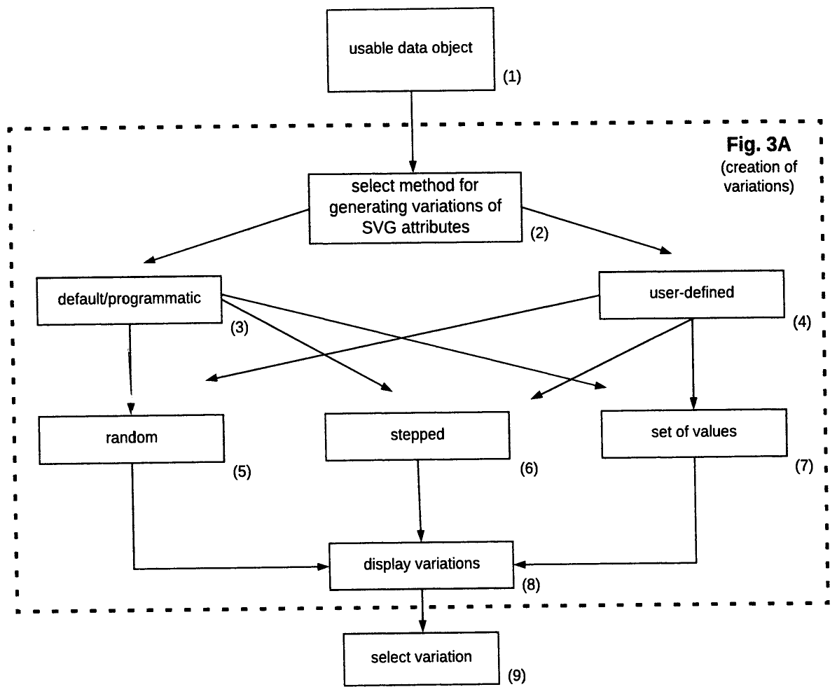

This method and system then provides for manipulation of the master SVG image by varying the values of one or more of the properties or variables (i.e. stroke, color, hue, lightness, saturation, gradient, opacity, rotation, scale, etc.). FIG. 3. This process can be used to create multiple variations from the master image by a programmatic operation in two principal ways. FIG. 1(7), FIG. 3, FIG. 3A(2).

The first assigns a number of stepped (FIG. 3A(6)) or random values (FIG. 3A(5)) or a set of preselected values (FIG. 3A(7)) within program-defined parameters to the property or properties in the database for the attribute of the image the user wishes to vary. FIG. 3A(4). The second assigns a number of stepped (FIG. 3A(6)) or random values (FIG. 3A(5)) or a set of preselected values (FIG. 3A(7)), as chosen by the user. FIG. 3A(3).

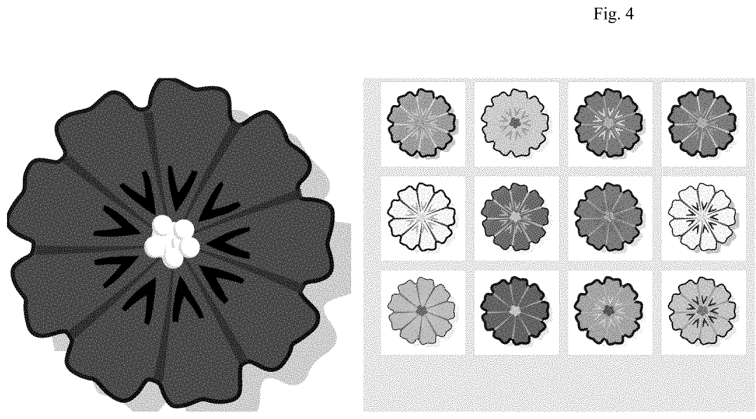

The result of these operations would be one or more interim SVG images that may then be simultaneously displayed with the master image in the user interface. FIG. 1(7), FIG. 3A(8), FIG. 4, FIG. 5. The number of unique interim images is limited only by the number of possible values in the properties being manipulated. This process in another embodiment would provide the mechanism for programmatic manipulation of the image, drawing property values from information gathered about common settings or trends seen from a user or users of this particular master image, or by drawing from other images with similar keywords.

The user can then select one of the interim images as displayed in the user interface (FIG. 1(8), FIG. 3A(9)) to become the master image and to be manipulated as provided above, but with more narrowly defined parameters (i.e. replacement of the colors in the pallette with only those in the new master image). This method and process can be repeated until the user has created an image or images that the user selects to be saved or exported for use. FIG. 1(9).

### 4. Detailed Description of Drawings.

As further illustration of the implementation of the embodiment described above, Applicant herein describes the drawings submitted in further detail.

FIG. 1:

FIG. 1 depicts a flowchart of the preferred embodiment of the method and system in its entirety as reflected in claim 1, and other claims referencing claim 1 directly or indirectly.

The process begins with the master SVG image, the digital code for which may be imported from an outside source or created using a graphics editing program such as Adobe Illustrator or Inkscape. FIG. 1(1).

The first step in the method and system uses an algorithm to determine if the master SVG image is a compound image, consisting of multiple elements (paths or shapes) that have been converted into a single compound image, or an image that doesn't consist of a single compound image. FIG. 1(2).

If the image is a compound image, the image data is parsed in a process where the compound path is split into multiple elements, and each element is parsed for usable information (i.e. path or shape definition, scale, color, hue, luminosity, saturation, opacity, stroke width and/or stroke color) to contribute to the data object. FIG. 1(3), FIG. 2, FIG. 2A, and FIG. 2B.

If the image is not a compound image, the data for each individual element (path or defined shape) is parsed to extract information from each element (i.e. path or shape definition, scale, color, hue, luminosity, saturation, opacity, stroke width and/or stroke color). FIG. 1(4). Then, for complex images, those elements with identical (or similar) colors are placed in color groupings to be included in the data object for that image so the paths with identical (or similar) colors may be manipulated together as described herein. FIG. 1(5).

The output of this data parsing of the master image, whether compound or not, is placed into a non-relational database (such as JSON) to create a data object(s) representing that master image. FIG. 1(6).

Once the data object has been created for the image, this data is used to create variations for the image by substituting a value or values for one or more of the attributes in the data object(s). FIG. 1(7), FIG. 3, and FIG. 3A.

Selecting one of the variations will then reset the base data for that image, and the process can be repeated whereby the user can create a new set of variations according to the default/programmatic or user-specified settings. FIG. 1(8).

When the user has selected a final image or images through this iterative process, the image(s) may be exported as SVG or other format. FIG. 1(9).

FIG. 2:

FIG. 2 is a more detailed flowchart of a part of FIG. 1 that illustrates the method and the process of intelligently splitting a compound path(s) and parsing of the data for each element into a usable data object(s).

A programmatic operation has been run that identified and split the compound image into data array for each separately identifiable element (path or shape definition) of the compound image. FIG. 2(1). This parsed data creates a data object(s) for the image. FIG. 2(2). This data object(s) is then processed to correct for obstructed image elements FIG. 2(3) (FIG. 2A), and to group elements related by symmetry FIG. 2(4) (FIG. 2B). The end result is a usable data object for the SVG image, which contains intelligence that can be used for further manipulating the image and creating variations. FIG. 2(5).

FIG. 2A:

FIG. 2A is a flowchart of a part of FIG. 2 that illustrates the process by which elements (paths and/or shapes) are sorted to correct for elements that fully obstruct others.

The minimum and maximum x and y values of each element are used to compare to other elements in the image to determine if any element is fully obstructed by another. An algorithm (i.e. a bubble sort) is performed (FIG. 2A(2)), whereby any element whose bounds are fully within another is placed in order so that it is displayed on top (to be visible) of the element within whose bounds it falls. This process returns the sorted paths in an array to set the order of the paths in the data object for the image. FIG. 2A(3).

FIG. 2B:

FIG. 2B is a flowchart of part of FIG. 2 that illustrates the process by which symmetrical elements derived from split compound images are grouped for purposes of manipulating those elements identically (i.e. an identical color for all elements in a group). To accomplish this processing of the image, the parsing of each individual element includes the establishment of a data object(s) for x and y symmetry. FIG. 2B(2).

Then, the x and y start position for each element is determined. FIG. 2B(3). As that operation is run, the result is compared to determine if the data symmetry object already has a key set for that number. FIG. 2B(4). If the symmetry object does already have this number already set as a key, this index number for this element is pushed into the array for this existing key. FIG. 2B(5). If the symmetry object does not have a key matching this number, a key is added to the symmetry object using this number. FIG. 2B(6). The index number of the current element is then pushed into the array of values for the key that was just created. FIG. 2B(7).

The symmetry data objects are then used to establish color (or other attribute) groups on either the x or y axis. FIG. 2B(8).

This completes the processing of the compound image into usable data objects as depicted on FIG. 1(6). FIG. 2B(9).

FIG. 3:

FIG. 3 is a flowchart of part of FIG. 1 that illustrates a process and method of creating image variations by varying one or more of the properties (i.e. stroke, color, hue, lightness, saturation, gradient, opacity, rotation, scale, etc.) of one or more of the elements contained in the usable data object(s) within certain defined parameters and using a predetermined method of creating those variations.

Through a user interface, the user is presented with properties they can choose to vary, and selects one or more of those properties on which to create variations. FIG. 3(2). The user may then select certain parameters within which these variations are to be created. FIG. 3(3).

The final step is to create the variations by applying values selected either by the user or by default or programmatically. FIG. 3(4) (FIG. 3A).

These values are then applied to the variations, and they are updated in real time.

FIG. 3A:

FIG. 3A is a flowchart of a part of FIG. 3 that illustrates the process by which properties are applied to create image variations. Typically, if the user does not specify user-defined properties for the image being varied, the default or pre-defined programmatic definitions will be applied. FIG. 3A(3). Otherwise, the properties or range of properties chosen by the user will be used. FIG. 3A(4).

The variations in a property can be accomplished in 3 different ways, regardless of whether they are user-defined or programmatic/default settings.

The variations can be created be setting the values for the selected property in a random fashion (FIG. 3A(5)), by setting the values in steps from within a range or from a base number or color (FIG. 3A(6)), or by the selection of individual values from a set of values (i.e. a palette of colors) (FIG. 3A(7)).

For example, if variations of stroke width are the desired result. The three methods would produce the following results (assuming a range of 0-5 was set):
if random: each of the selected number of variations would have a stroke width chosen randomly between 0 and 5 (i.e. 0.1, 1.1, 2.1, 2.4, 4.5).
if stepped: each of the selected number of variations would be a value equally divided between 0 and 5 (i.e. if number of variations was 6, then the stroke widths would be 0, 1, 2, 3, 4 and 5).
if from a set of values: each variation would be chosen from a selected set of values (i.e. 0, 0.1, 0.3, 1, 2, and 5).

The variations are updated in real time for the user to view and compare. (FIG. 3A(8)).

FIG. 4:

FIG. 4 is an example of a user interface displaying the master SVG image with 12 variations created using the method and system described herein, where both the color (grayscale) and stroke have been varied. The stroke has been varied within a range of values, producing varying thicknesses.

FIG. 5:

FIG. 5 is an example of a user interface displaying the master SVG image with 12 variations created using the method and system described herein, illustrating stepped color (grayscale) variations for the skin color element (with the color of other elements of the image fixed and others varied randomly).

1. A computer method and system to create derivative SVG images by parsing the original or master image into data array(s), group(s) and data object(s) in a nonrelational database, such as JSON, by performing operations as necessary to put that data into a useful form, by manipulating the values for the properties in the data object(s) of the master image, and by then performing such operations as necessary to display and/or download the resulting derivative image or images.

2. As to the method and system described in claim 1, a computer method and system for the creation of a useful data object(s) for an existing compound path SVG graphic image for purposes of creating variations or derivatives of that image by running a programmatic operation that cuts that compound path and parses each constituent path or shape from its XML form into a data array to create an element for each path or shape, and combines this information for the elements into a data object(s) for that image in a non-relational database (i.e. JSON).

3. As to the method and system of claim 2, following the creation of a useful data form of the master image as described in claims 2, a method and system to determine symmetry on the x and/or y axes and color the image symmetrically using a programmatic operation to compare the starting points of the paths for those elements to determine if any elements are symmetrical on the x and/or y axes, and then group symmetrical elements or shapes within the image for purposes of symmetric coloration of that image.

4. As to the method and system described in claim 2, a method and system using a computer to detect and correct errors in organization of the elements as necessary to allow the proper viewing of all elements using a programmatic operation that compares the top, bottom, left and right dimensions and position of the elements of an image and reorders the elements to correct for any obstruction.

5. As to the method and system described in claim 2, a method and system of displaying the different paths and/or shapes of the compound path image as parsed into multiple elements in the nonrelational database (i.e. JSON) data object by applying a different color from a palette of colors to identify and differentiate each element.

6. As to the method and system of claim 1, a method and system wherein the creation of a useful data object for an existing complex image is accomplished by an operation parsing the data from the image into a nonrelational database (i.e. JSON) format and placing the properties of each of the elements contained in that image into the data object(s) for that image, including the creation of color groups based upon existing similar colors in the master image.

7. As to the method and system of claim 1, following the creation of a useful data form of the master image, a method and system wherein a programmatic operation simultaneously creates multiple derivative images from the master image by assigning a number of different values for a property or properties contained in the data object(s) for the master image.

8. As to the method and system of claim 7, wherein a programmatic operation simultaneously creates multiple derivative images from the master image by assigning a number of values as chosen by the user from a specific user-defined or program-defined set of values for a property or properties, such as hue, luminosity, saturation, stroke, scale, rotation or opacity, contained in the data object(s) of the master image.

9. The method and system of claim 7, wherein an operation simultaneously creates multiple derivative images from the master image by assigning a number of stepped values, from within user-defined or program-defined parameters, in a property or properties, such as luminosity, contained in the data object(s) of the master image.

10. The method and system of claim 7, wherein an operation simultaneously creates multiple derivative images from the master image by assigning a number of values, chosen randomly from within user-defined or program-defined parameters, to a property contained in the data object(s) of the master image.

11. The method and system of claim 1, wherein one of the multiple derivative images, resulting from the manipulation of the master image in the manner described above, becomes the new master image upon which the process and system described in claim 1 can be repeated, but within parameters more narrowly defined by the user through the user interface or programmatically.
